(19) United States
(12) Patent Application Publication
(10) Pub. No.: US 2013/0292532 A1
(43) Pub. Date: Nov. 7, 2013

(54) POWER HEAD AND ATTACHEMENT STORAGE ADAPTOR

(71) Applicant: Brian Mikes, Ball Ground, GA (US)

(72) Inventor: Brian Mikes, Ball Ground, GA (US)

(21) Appl. No.: 13/803,544

(22) Filed: Mar. 14, 2013

Related U.S. Application Data
(60) Provisional application No. 61/641,863, filed on May 2, 2012.

(51) Int. Cl. F16M 13/02

(52) U.S. Cl. CPC F16M 13/02
USPC 248/314

(57) ABSTRACT

An adaptor device for the hanging storage of a lawn trimmer attachment. The adaptor having a lower portion with a first end, an upper portion with a second end, and includes a central axis extending from the first end to the second end. An opening is formed within the lower portion of the adaptor at first end and configured for receiving a lawn trimmer attachment therein. A cutout is formed within the lower portion of the adaptor. The cutout extends from the first end and in the direction of the second end. The cutout also extends in a second direction. The second direction having a component from the second end to the first end along the central axis of the adaptor. The cutout then terminating within the hole and thus forming a J shaped cutout. The upper portion of the adaptor including an opening for hanging the adaptor and lawn trimmer attachment from a support structure.

### CROSS-REFERENCE TO RELATED APPLICATION

This application claims the benefit of U.S. Provisional Application Ser. No. 61/641,863, filed on May 2, 2012, the entirety of which is hereby incorporated herein by reference.

### BACKGROUND OF THE INVENTION

1. Field of the Invention The present invention generally relates to apparatuses for the storage of lawn and pool care equipment. More particularly, the present invention relates to storage adaptors to readily allow the hanging storage of motorized power heads and mating attachments used in lawn and pool care.

2. Description of the Related Art

Lawn care power equipment such as line trimmers, edgers and brush saws are common tools in residential and commercial settings. Many designs utilize a power head containing a gas or electric motor which connects with and provides power to a variety of attachments. Such configuration allows a single power head to be purchased, which may then be readily used to drive any one of multiple lawn care attachments. With reference to the figures in which like numerals represent like elements throughout, FIG. 1 is a side perspective view of the mating sections of a typical power head 10 and attachment 30. The power head 10 is typically a female tube configured to have a male attachment inserted within. In a typical design, a shaft within the power head assembly supplies rotational motion to a shaft in the mating attachment 30. As the power head 10 and accessory attachment 30 are engaged, a splined shaft in the power head assembly mates with a complimentary splined shaft in the attachment assembly. In many manufacturers design, retention pins 32 on the exterior of the attachment 30 are configured to engage recesses or holes 12 within the power head 10 to retain the power head and attachment together. In other manufactures designs, the retention pins are integral with the power head unit and engage the body of the attachment.

As shown in FIG. 2, to engage the power head 10 and attachment 30, the spring pins 32 are depressed in the direction of Arrow “A” and the attachment is slid into the power head body in the direction of Arrow “B”. As further depicted in FIG. 3, the power head 10 and attachment 30 are mated when the spring pins 32 engage the holes or recesses 12.

Storage of power equipment within the garages of both residential and commercial buildings can be problematic. The power tools represent a substantial investment and need be stored in a manner to protect them from damage. The tools are somewhat heavy and can present a danger to personnel if simply hung from a nail or leaned against a wall. When a power head with accessories is purchased, the owner is faced with the storage of several components. Hanging storage adjacent a wall is ideal for the oblong nature of the power head and attachments. A variety of manufacturers currently offer garage tool storage wall mounting systems which may be configured with horizontal rods, horizontal brackets, or spaced pins. The tool storage wall mounting systems are commonly used to hang hand tools such as rakes, shovels and the like.

According, it would be advantageous to provide adaptor devices to readily allow the hanging storage of power equipment power heads and attachments. Such devices should accommodate the power head dimensions, the attachment dimensions, and the mating configurations of a broad range of power tool manufactures present in the market. The device should also be able to function with a broad range of the tool storage wall mounting systems currently available in the market. The device would allow the ready storage of the tool components when not in use, and allow ready access when the power head and an accessory is selected for use. The device should also protect the critical mating surfaces and power transmission components of the power head and accessory from damage, dust, and debris during storage. Finally, the device should allow the attractive display of the tools and provide for a neat and organized appearance of the garage or tool storage area. It is thus to such a storage fixture for the hanging storage of power heads and attachments that the present invention is primarily directed.

### SUMMARY OF THE INVENTION

The disadvantages of the prior art are overcome by the present invention which, in one aspect, is an adaptor device for the hanging storage of a lawn trimmer attachment. The adaptor includes a lower portion with a first distal end and an upper portion with a second distal end. The adaptor further includes a central axis extending from the first distal end to the second distal end, and having an exterior surface. Wherein an opening is formed within the lower portion of the adaptor at the first distal end configured for receiving a lawn trimmer attachment therein. The lower portion includes a hole within the lawn trimmer attachment opening for receiving a pin on the lawn trimmer attachment. The upper portion has an opening for receiving a hanging support structure therein. In another aspect of the present invention, the opening for receiving the lawn trimmer attachment further extends thru the upper portions of the adaptor and exits the second distal end to form an elongate tube. The hole for receiving the lawn trimmer attachment pin is a hole extending from the lawn trimmer attachment opening thru the body of the adaptor to the exterior surface.

In another aspect of the present invention, a cutout is formed within the lower portion of the adaptor body. The cutout extends in a first direction from the first distal end towards the second distal end and substantially parallel to the central axis of the adaptor body. The cutout then extends in a second direction from the termination of the first direction. The second direction comprising a first vector component from the second distal end to the first distal end and a second vector component perpendicular to the central axis of the adaptor body. The cutout then terminates within the hole. The cutout thereby forming a generally J shaped opening in the adaptor body.

In another aspect of the present invention, a pin is supported by a spring element on the exterior surface of the adaptor. The pin and spring element configured to move from a first retracted position to a second extended position. A hole is formed thru the adaptor from the opening within the lower portion to the exterior surface. The pin is urged to extend within the hole when the pin and spring element are in the second extended position. The pin is configured to engage a corresponding recess in the lawn trimmer attachment.

In other aspects of the present invention, the opening for receiving the lawn trimmer attachment has a minimum dimension perpendicular to the central axis of the adaptor of greater than 1.02 inch. The lower portion of the adaptor has a maximum dimension perpendicular to the central axis of the adaptor of less than 1.126 inch. The adaptor may be fabricated from extruded metal tube, injection molded plastic, thermo-formed plastic, or any combination thereof.

In yet another aspect, the present invention includes an adaptor device for the hanging storage of a lawn trimmer power head. The adaptor includes a lower portion with a first distal end, and an upper portion with a second distal end. The adaptor further includes a central axis extending from the first distal end to the second distal end, and an exterior surface. An opening is formed within the lower portion at first distal end configured for receiving a portion of a lawn trimmer power head therein. At least one hole is formed thru the body of the adaptor from the opening within the lower portion to the exterior surface. A pin is retained within the lower portion of the adaptor, the pin configured to engage a corresponding recess in a lawn trimmer power head. The pin is urged to an extended position by a spring element. The pin when in the extended position passes thru the at least one hole in the body of adaptor and protruding out of the exterior surface of the adaptor in a direction perpendicular to the central axis. The upper portion of the adapter includes an opening for hanging from a support structure.

The opening for receiving a portion of the lawn trimmer power head further extends thru the upper portions of the adaptor and exits the second distal end to form an elongate tube. The at least one first pin and first spring element may be readily removed from the adaptor. A lawn trimmer power head having an integral second pin may be inserted into the opening within the lower portion of the adaptor, the integral second pin engaging the at least one hole.

In yet other aspects of the present invention, the lower portion of the adaptor has a maximum dimension perpendicular to the central axis of the adaptor of less than 0.976 inch. The opening within the lower portion of the adaptor for receiving the lawn trimmer power head has a minimum dimension perpendicular to the central axis of the adaptor of greater than 0.902 inch. The adaptor may be fabricated from metal tube, injection molded plastic, thermo-formed plastic, or any combination thereof.

In yet another aspect, the present invention includes an adaptor device for the hanging storage of a pool attachment. The adaptor includes a lower portion with a first distal end, and an upper portion with a second distal end. The adaptor further includes a central axis extending from the first distal end to the second distal end, and an exterior surface. An opening is formed within the lower portion of the adaptor at the first distal end configured for receiving a pool attachment therein. A cutout is formed within the lower portion of the adaptor, the cutout extending from the first distal end and in the direction of the second distal end. The cutout also extends in a second direction, the second direction having a component from the second distal end to the first distal end along the central axis of the adaptor. The cutout then terminating within the hole and forming a J shaped cutout. The upper portion of the adaptor includes an opening for receiving a hanging support structure therein.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE DRAWINGS

FIG. 1 is a side-perspective view of a prior art power tool comprising the mating components of a power head and accessory attachment.

FIG. 2 is a side-perspective view illustrating the engagement of the prior art power head and accessory.

FIG. 3 is a side-perspective view illustrating a fully engaged prior art power head and accessory.

FIG. 4 is a side-perspective view illustrating the lower portion of a power head and power head hanging storage adaptor.

FIG. 5 is a side-perspective view illustrating the lower portion of a power head engaged with the power head hanging storage adaptor.

FIG. 6 a side-perspective view illustrating the upper portion of an attachment and a attachment hanging storage adaptor. FIG. 7 is a side-perspective view illustrating the upper portion of the attachment being inserted within the attachment hanging storage adaptor.

FIG. 8 is a side-perspective view illustrating the upper portion of the attachment engaged with the attachment hanging storage adaptor.

FIG. 9 is a side-perspective view illustrating the spring and retention pins removed from the power head hanging storage adaptor.

FIG. 10 is a cutaway side-perspective view illustrating the power head hanging storage adaptor of FIG. 9, with spring and pins removed, and engaged with a power head unit.

FIG. 11 is a side-perspective view illustrating an attachment hanging storage adaptor with external retention pin and spring.

FIG. 12 is a side-perspective view illustrating the insertion of the upper portion of an attachment within the attachment hanging storage adaptor of FIG. 11.

FIG. 13 is a side-perspective view illustrating the upper portion of an attachment engaged with the attachment hanging storage adaptor of FIG. 11.

FIG. 14 depicts a power head adaptor and three attachment adaptors suspended from a support structure.

FIG. 15 depicts an alternative embodiment of the power head adaptor and attachment adaptor for receiving a hanging support structure therein.

FIG. 16 is a side-perspective view illustrating an alternative embodiment of the attachment hanging storage adaptor with external retention pin and spring.

FIGS. 17-18 are side-perspective views illustrating a pool attachment hanging storage adaptor.

FIG. 19 depicts a three pool attachment adaptors with engaged pool attachments suspended from a support structure.

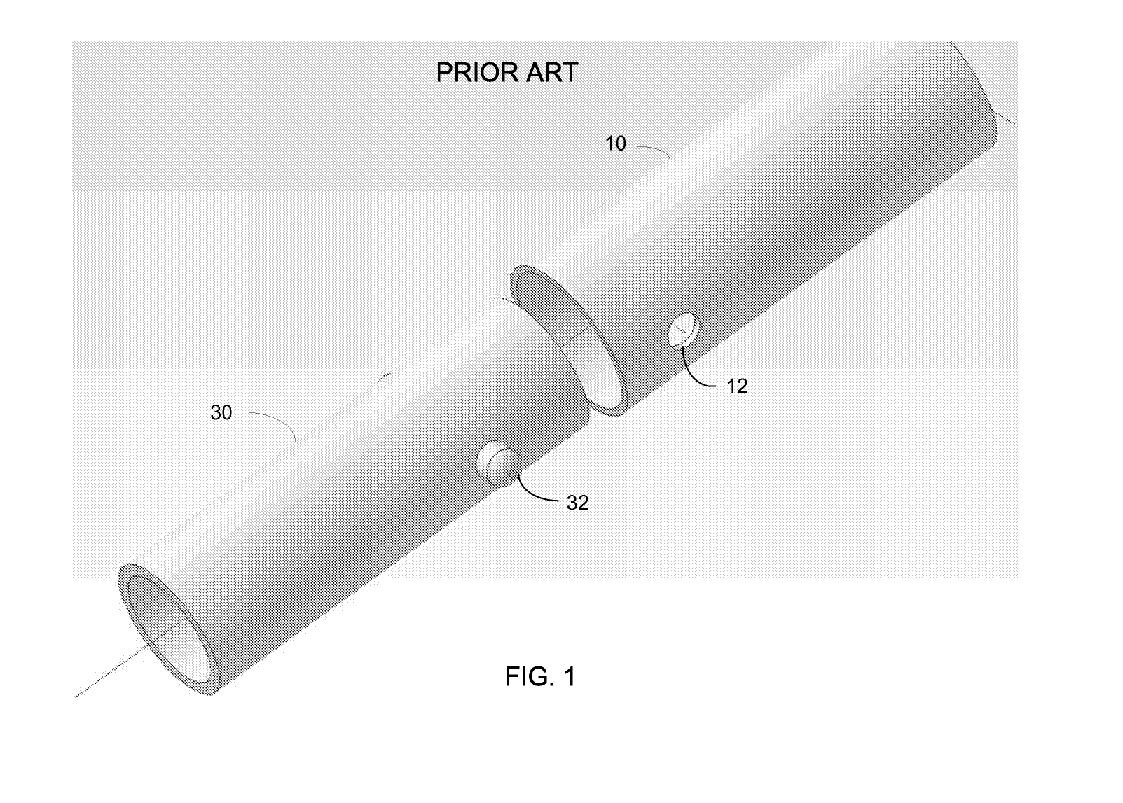

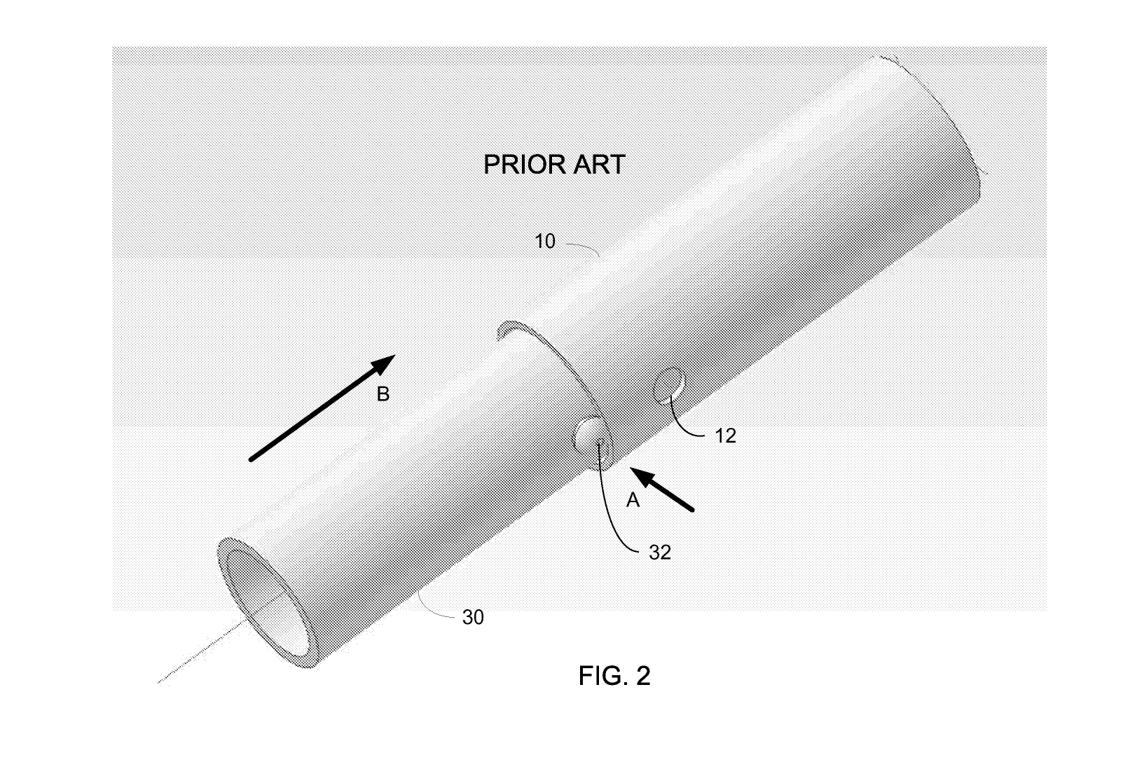

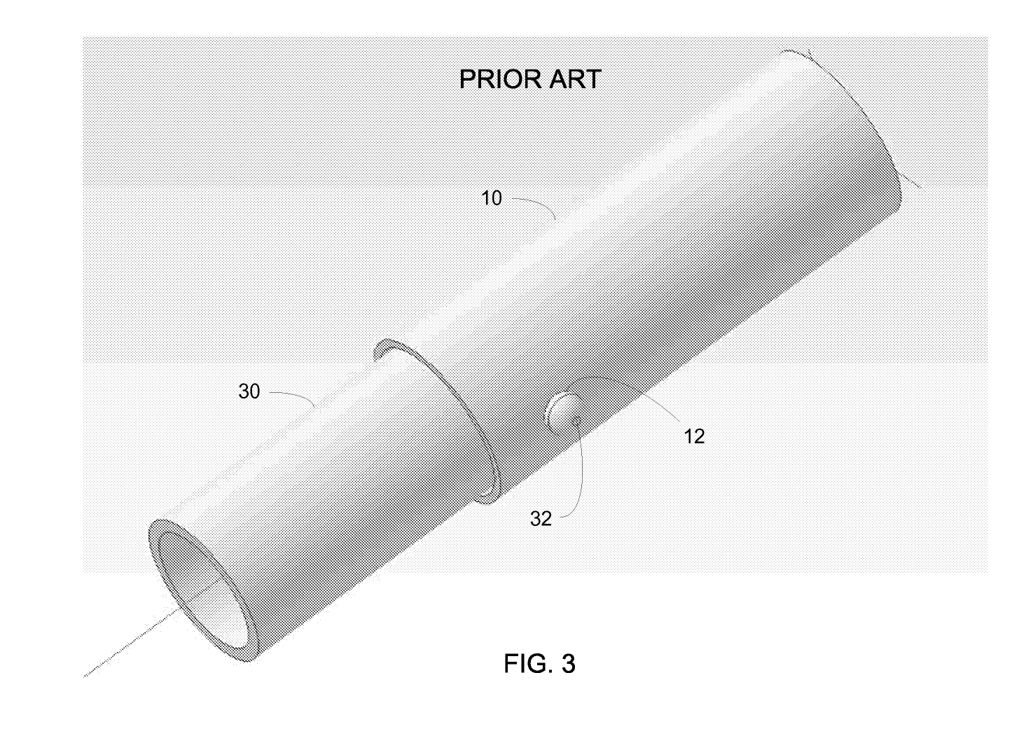

### DETAILED DESCRIPTION OF THE INVENTION

The power head storage adaptor and attachment storage adaptor of the present invention provide devices to readily allow the hanging storage of power equipment products having motorized power heads and mating lawn and pool care attachments. The devices accommodate the power head dimensions, the attachment dimensions, and the mating configurations of many power equipment manufactures. The adaptors also function with a broad range of the tool storage wall mounting systems currently on the market. Each device allows the ready hanging storage of the tool components when not in use, and also allows the ready access when the power head and an accessory attachment are selected for use. The storage adaptors protect the critical mating surfaces and power transmission components of the power head and the attachment from damage, dust, and debris during storage and facilitate an organized storage solution.

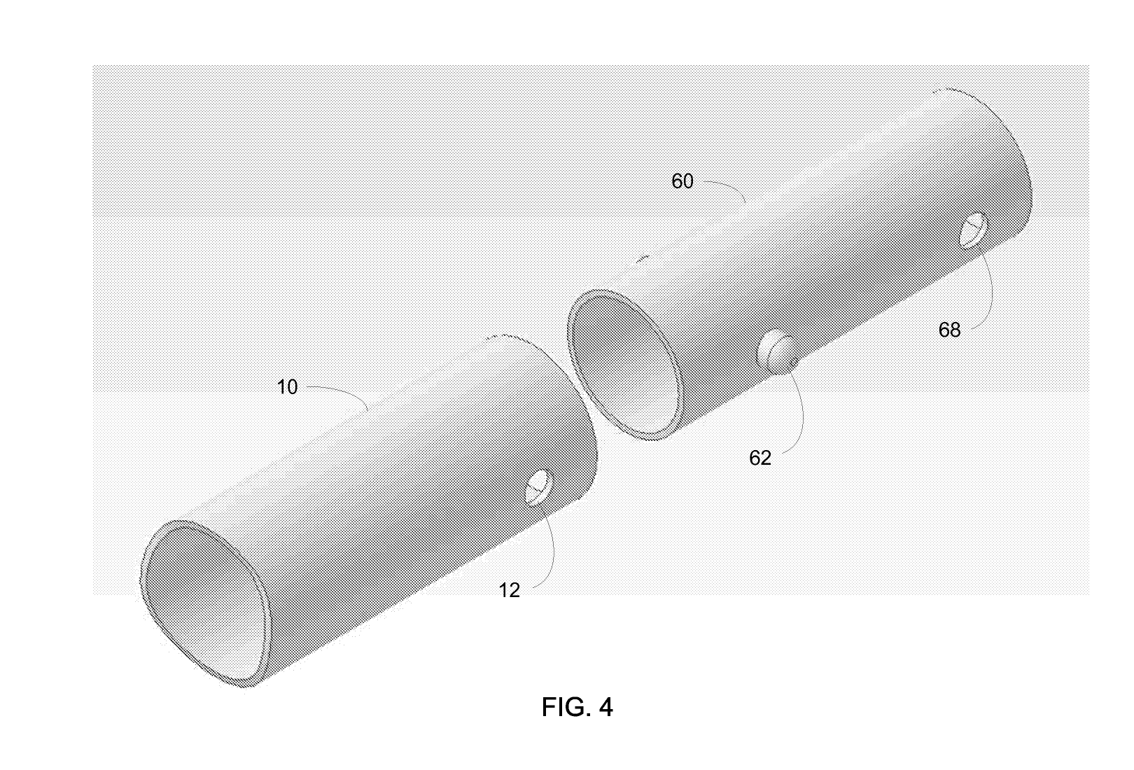

In a first embodiment of the present invention, an adaptor for the hanging storage of a power head unit is depicted in FIG. 4. The end of the power head 10 is depicted in FIG. 4 pointing up and to the right. The end of the power head 10 forms a tube for receiving an attachment within. A hole 12, or shallow recess 12, is formed within the power head 10 tube and is configured to receive a locking pin of the attachment.

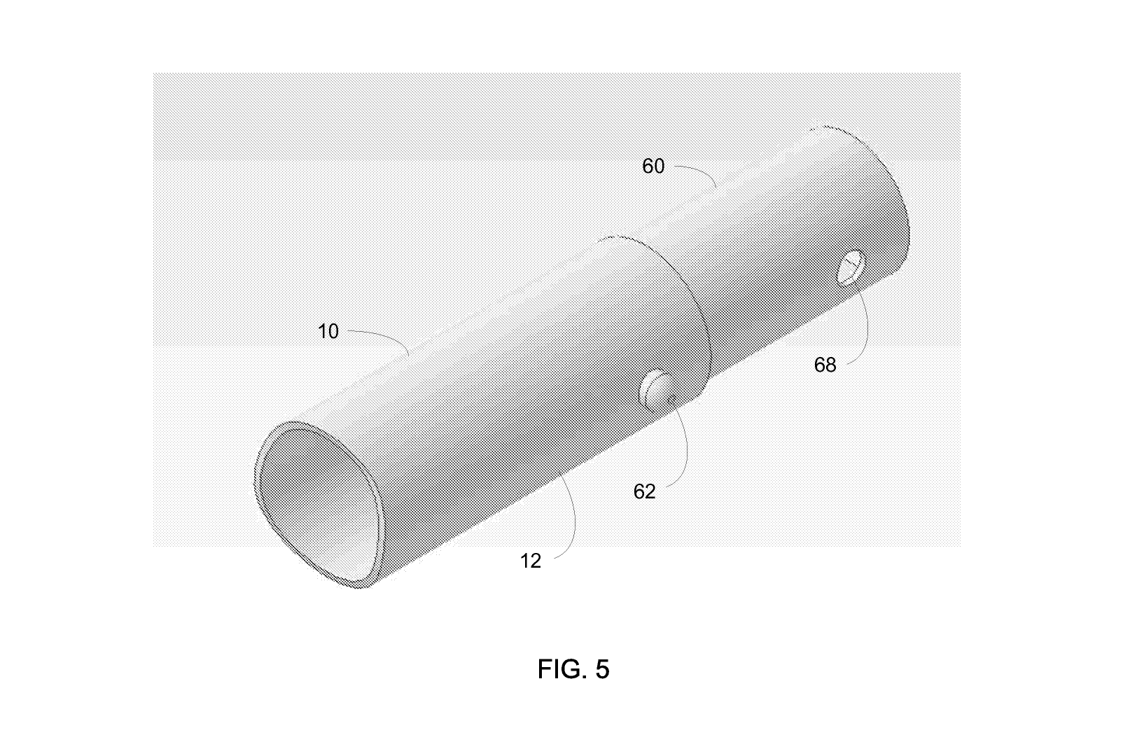

The power head adaptor 60 is an elongate tube and is configured to be received within the power head unit 10. The power head adaptor 60 is configured with retention pins 62 which are urged by springs out of the adapter body. As depicted in FIG. 5, the pins 62 of the power head adaptor 60 may be pushed inward and the adaptor 60 slid within the power head 10. The pins 62 are then urged by the spring element out of the adaptor 60 body and engage the hole or recess 12 within the power head 10. The power head 10 is then positively engaged with the power head adaptor 60 device. An opening 68 in the body of the adaptor device 60 allows hanging the power head 10 and adaptor assembly 60 from a support structure.

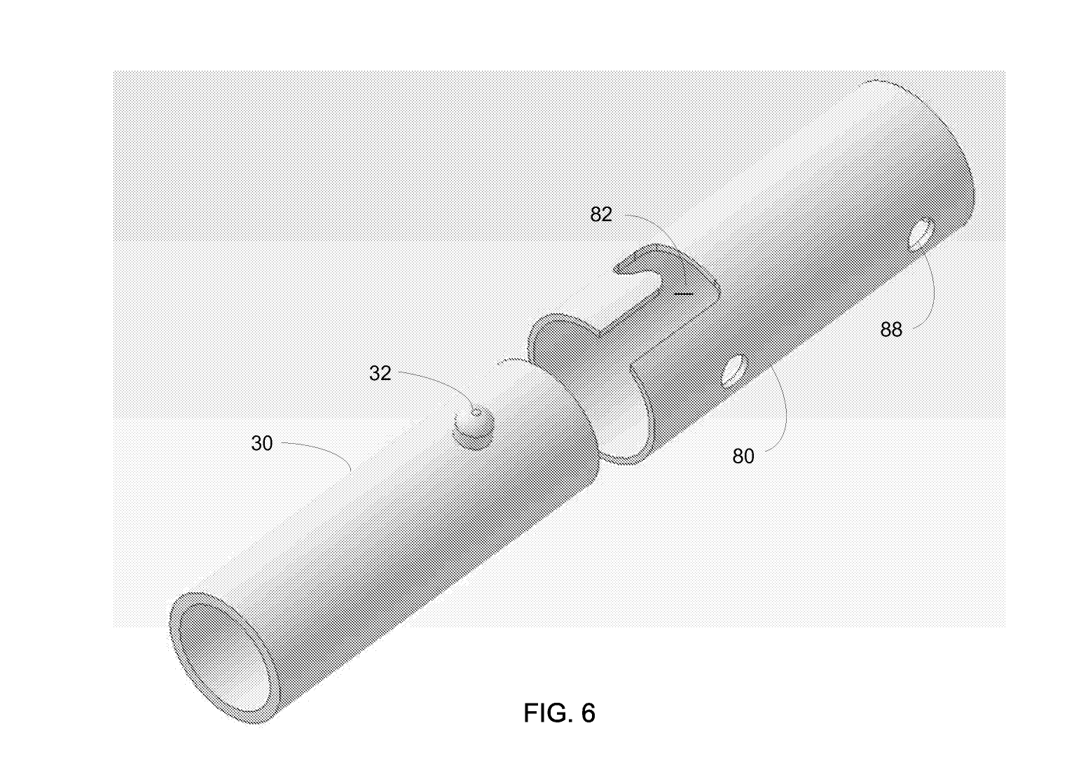

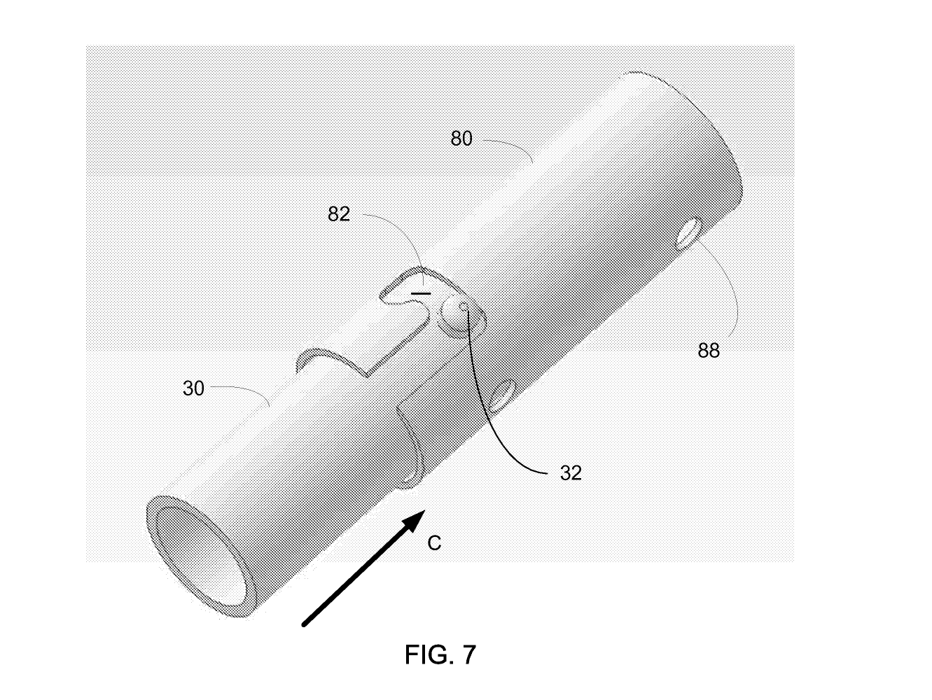

As may be appreciated by those skilled in the art, some manufacturers use a single pin to engage the power head 10 to the attachment 30, while other manufactures use multiple pins to secure the units together. As depicted in FIG. 5, the power head adaptor 60 has two retention pins. In applications supporting a power head which uses a single retention pin, the additional retention pin may be simply compressed via the pin spring within the power head adaptor body 60. In a second embodiment of the present invention, an adaptor for the hanging storage of an attachment unit is depicted in FIG. 6. The end of the attachment 30 is depicted in FIG. 6 pointing up and to the right. The end of the attachment 30 is configured to be received within the end of a power head unit. A locking pin 32 is retained within the attachment 30 and is urged out of the attachment body by a spring element.

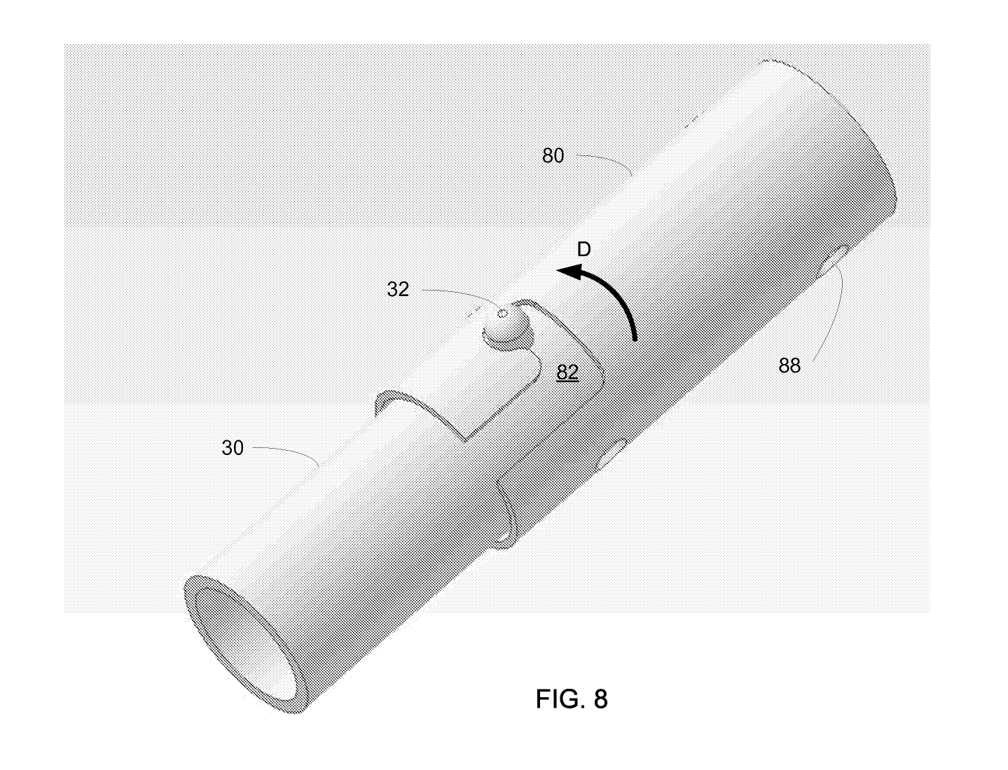

The attachment adaptor device is an elongate tube and is configured to receive the attachment 30 within the lower end of the adaptor body 80. The lower end of the adaptor body 80 forms a tube for receiving the attachment 30 within. A shaped cutout 82 is formed in the sidewall of the tube portion of the adaptor body 80 lower end. As depicted in FIG. 7, the attachment 30 is inserted into the attachment adaptor 80 in the direction of Arrow “C”. The attachment pin 32 is received within the shaped cutout 82. As depicted in FIG. 8, the attachment 30 is then rotated in the direction of Arrow “D”. The attachment 30 is then positively engaged with the attachment adaptor 80 device. An opening 88 in the body of the adaptor device 60 allows hanging the attachment 30 and adaptor 80 assembly from a support structure.

As may be appreciated by those skilled in the art, some manufacturers use a single pin to engage the power head 10 to the attachment 30, while other manufactures use multiple pins to secure the units together. As depicted in FIGS. 6-8, the shaped cutout 82 can receive a single retention pin from the attachment 30. If the attachment design uses multiple pins, the additional pins may be compressed within the attachment body via the pin spring as the attachment is inserted into the attachment adaptor 80.

As depicted in FIGS. 6-8, the attachment adaptor 80 has an inverted “J” shaped cutout 82 for receiving the attachment retention pin. In alternative embodiments of the present invention, the accessory adaptor has; a hole for receiving the attachment retention pin, or a recess for receiving the retention pin. In all embodiments of the present invention, the cutout 82 is shaped such that when an axial load is applied in a direction pulling the attachment 30 out of the attachment adaptor 80, the retention pin 32 of the attachment 30 is retained within the attachment adaptor 80. As will be appreciated by those skilled in the art, any configuration of cutout 82 where a portion of the cutout angles down toward the lower end of the attachment adaptor and then terminates, will retain the pin, and thus the attachment within the adaptor. Stated another way, the path of the cutout 82 has a first direction from the first end to the second end of the adaptor along the central axis of the adaptor body. The path of the cutout 82 then changes directions, the second direction having a first vector component from the second end to the first end of the adaptor body, and a second vector component along the central axis of the adaptor body. The gradual change in direction of the cutout provided by the “J” shape is preferred to facilitate smooth insertion of the attachment within the adaptor. As will be appreciated by those skilled in the art, other cutout shapes may be utilized where the cutout terminates angled toward the lower end of the attachment adaptor.

The “J” shaped cutout 82 within the attachment adaptor 80 may extend from the inner surface through the adapter body to the outer surface as depicted in FIGS. 6-8. In alternative embodiments of the present invention, the “J” shaped cutout 82 forms a channel cut into the inner surface of attachment adaptor 80 but does not extend to the outer curved surface of attachment adaptor 80, or portions of the “J” shaped cutout 82 may be formed by channels which do not extend to the outer curved surface of attachment adaptor 80.

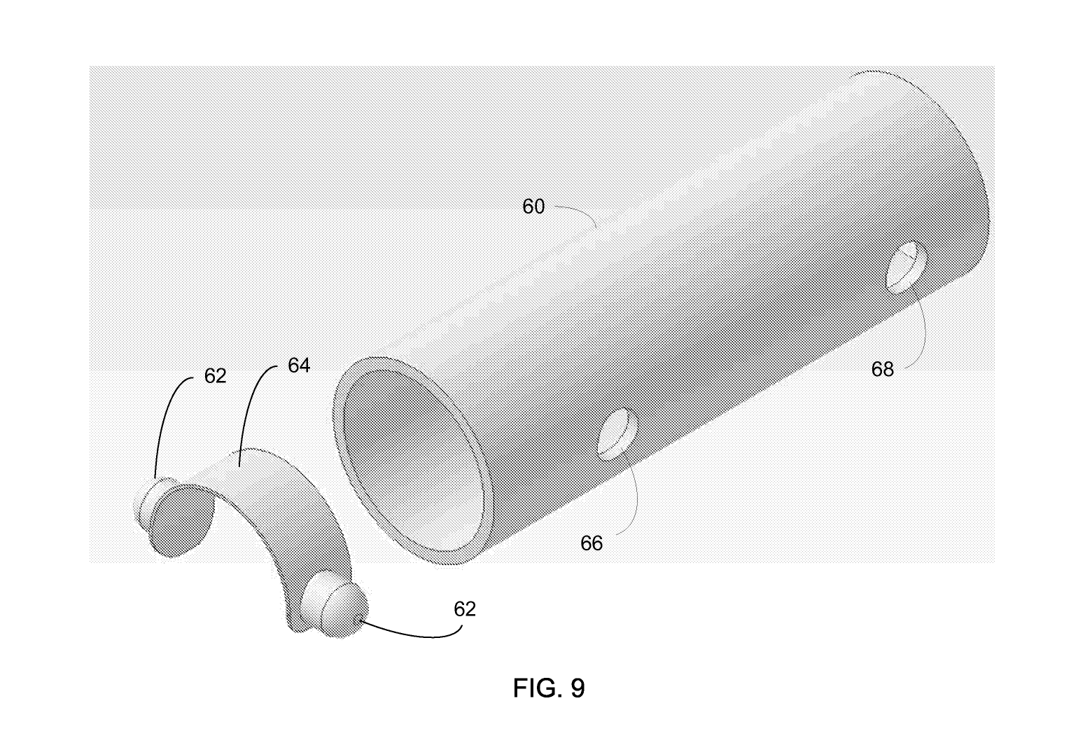

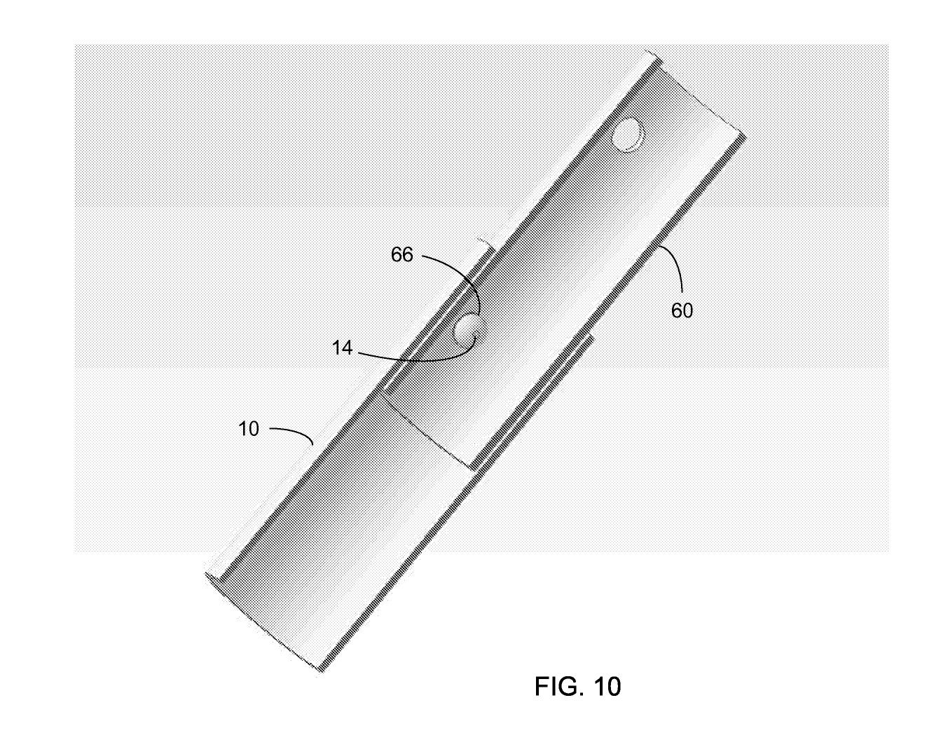

As will be appreciated by those skilled in the art, some power equipment manufacturers use a spring loaded retention pin within the body of the power head, and a complimentary hole within the body of the attachment. As depicted in FIG. 9, in another alternative embodiment of the present invention, the retention pins 62 and spring element 64 may be removed from the body of the power head adaptor 60. The retention pins 62 and spring element 64 are easily removed by squeezing the pins 62 into the holes 66 and pulling the assembly out of the adaptor 60. With the retention pins and spring removed from the adaptor 60, the power head 10 may then be engaged with power head adaptor 60 with the power head retention pin engaging the hole 66 in the adaptor body 60. FIG. 10 depicts a cutaway view of the mated power head 10 and power head adaptor 60, with the power head pin 14 extending into the hole 66 of the adaptor body 60.

In another alternative embodiment of the present invention, as depicted in FIG. 9, the retention pins 62 of the power head adaptor 60 are affixed to a curved piece of spring material 64. When installed within the adaptor 60, the curved spring 64 lies adjacent the inner surface of the adaptor body tube. As will be appreciated by those skilled in the art, the power heads of many power equipment manufacturers have internal structure that must extend within the power head storage adaptor. The curved spring configuration 64 provides clearance for the power head structure while providing the required spring force to positively engage the retention pins 62 with the holes 66.

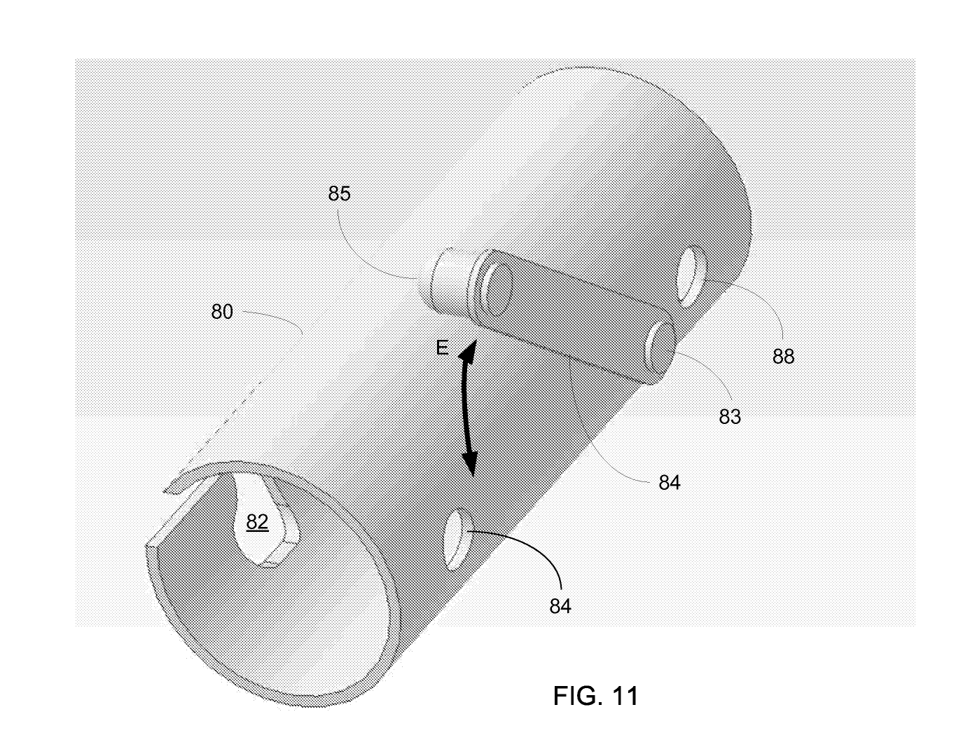

Another alternative embodiment of the invention is depicted in FIG. 11. For power equipment using a pin within the body of the power head and a complimentary hole, or shallow recess, within the body of the attachment, a retention pin must be provided on the attachment storage adapter. As depicted in FIG. 11, an arm 84 is mounted on the exterior of the attachment adaptor 80 via a rivet 83. A retention pin 85 is affixed to the end of the arm 84. The arm 84 is fabricated from a spring or elastic material to allow the pin to be deflected away from the body of the adaptor body 80. The rivet 83 allows the arm 84 to rotate relative to the attachment adaptor body 80 from a raised position to a lowered position as depicted by Arrow “E”. In the lowered position, the retention pin 85 aligns with a hole 86 in the body of the attachment storage adaptor 80. In the raised position, the arm 84, retention pin 85, and rivet 83 do not interfere with engaging the adaptor 80 with an attachment configured with a retention pin as depicted in FIGS. 6-8.

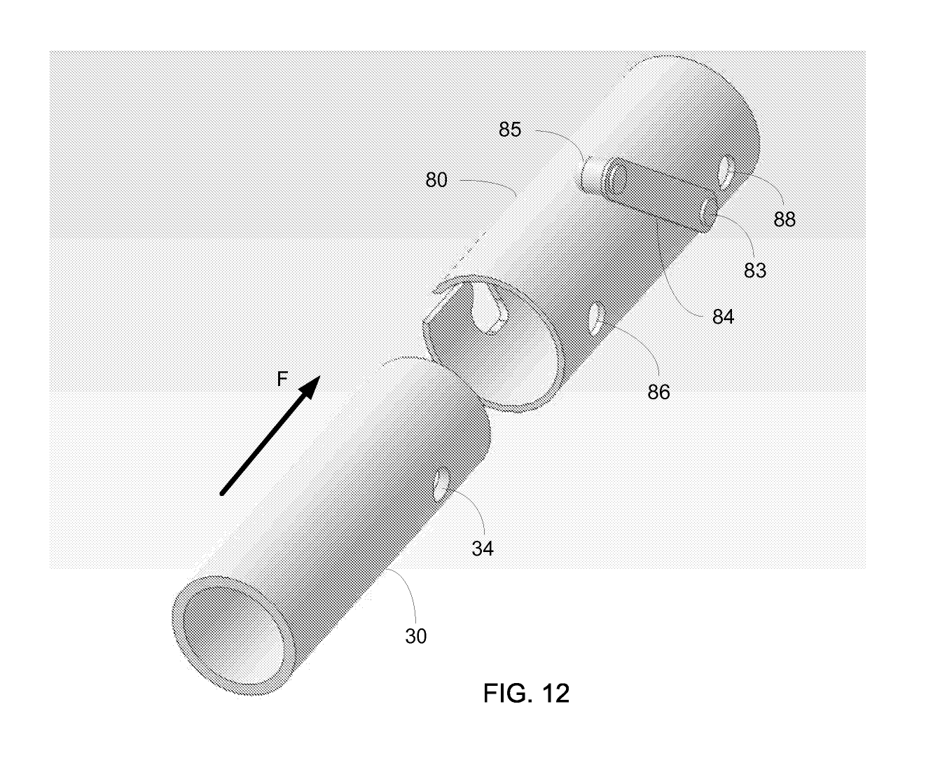

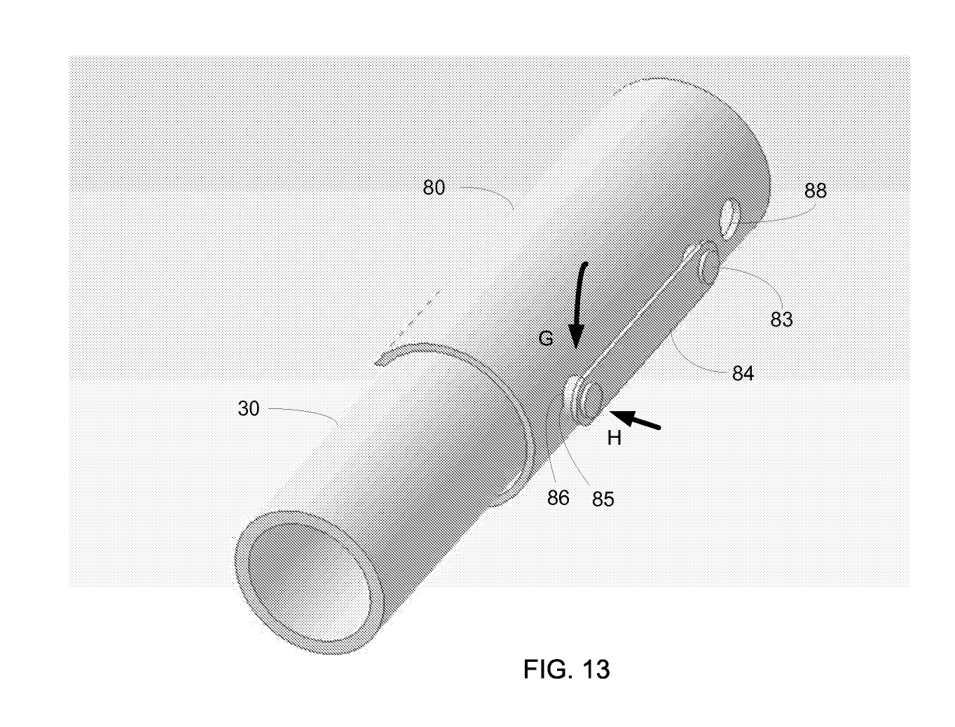

As depicted in FIG. 12, an attachment 30 with a complimentary hole 34, or recess 34, may be inserted within the attachment storage adaptor 30 in the direction of Arrow “F”. As further depicted in FIG. 13, when the complimentary hole 34 in the attachment 30 aligns with the hole 86 in the attachment storage adaptor 80, the arm 84 and retention pin 85 may be rotated down in the direction of Arrow “G”. The spring material of the arm 84 allows the assembly to be rotated down as the pin 85 makes contact with the exterior of the attachment adaptor 80. When the pin 85 aligns with the hole 86 in the adaptor 80, and the complimentary hole 34 in the attachment, the spring force of the arm 84 urges the pin in the direction of Arrow “H”. The pin 85 then positively retains the attachment 30 within the attachment storage adaptor 80.

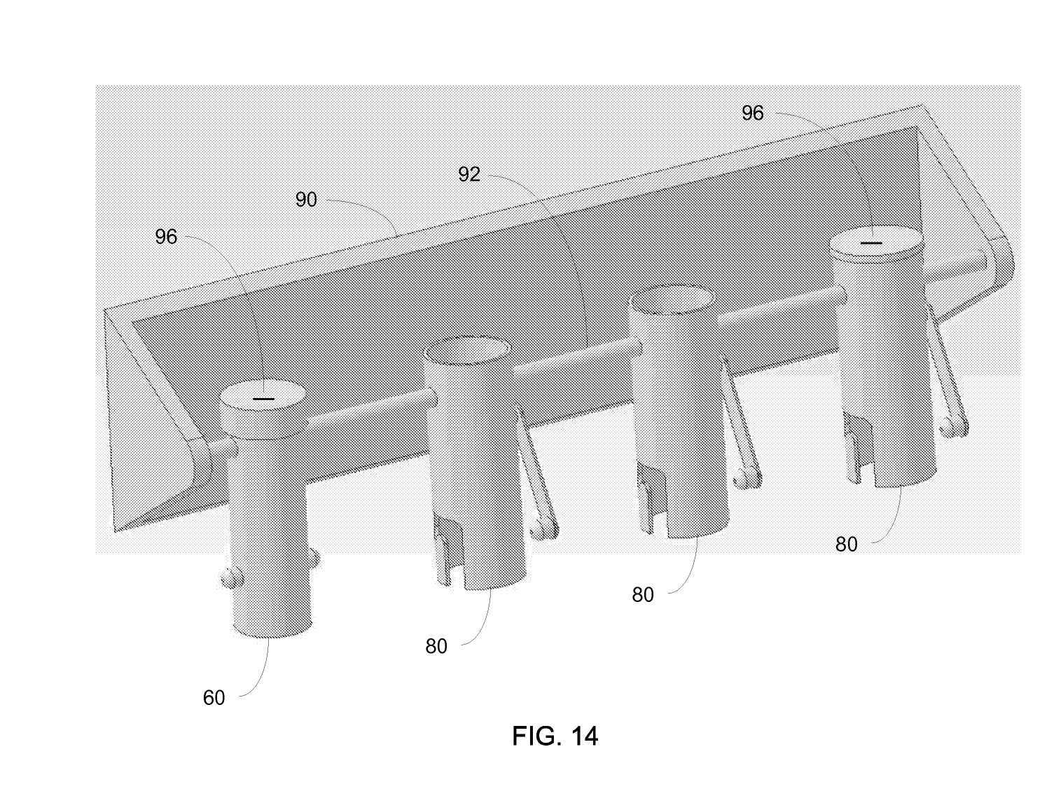

A power equipment power head or attachment may be suspended from a ceiling or wall surface using the adaptors of the present invention using a variety of support structures. As depicted in FIG. 14, in one embodiment a wall bracket 90 supports a horizontal rod 92. A power head adaptor 60, and three attachment adaptors 80 are shown supported by the horizontal rod 92 passing thru the respective openings 68, 88 in each adaptor body. In this configuration, one power head unit and up to three attachment units may then be neatly suspended from the wall bracket assembly. In another alternative embodiment, as depicted in FIG. 14, dust caps 96 may be installed over the upper ends of the power head adaptor and attachment adaptors. The dust caps 96 protect the critical mating surfaces and power transmission components of the power head and the attachment from damage, dust, and debris during storage. The dust caps are be molded plastic or rubber and slip over the exterior of the adaptor body, or may be inserted into the interior of the adaptor tube. In another alternative embodiment, the dust caps may be an integral component of the adaptor body.

As will be appreciated by those skilled in the art, a retail package of the adaptor devices of the present invention may include a single power head adaptor and a plurality of attachment adaptors. The adaptor devices are configured to use a variety of wall mounting and organizational systems currently on the market as the hanging support structure, or the adaptors may be supplied with a dedicated support structure.

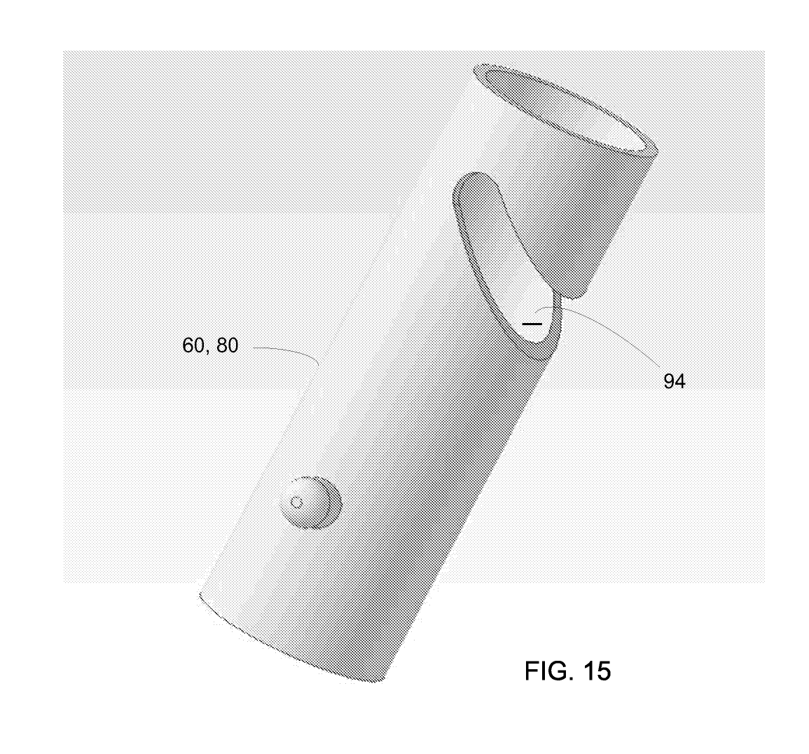

Yet another embodiment of the present invention is depicted in FIG. 15. The opening 68 for hanging the power head adaptor 60 is in the form of an angled slot 94 passing through the tube sidewall. The slot pierces the side of the adaptor tube 60, and angles up and away from the end of the adaptor for receiving the power head 10, and pierces the centerline of the adaptor tube body 60. The opening 88 in the attachment adaptor 80 may also be replaced with an angled slot passing through the tube sidewall. The slot 94 configuration may be readily used in a wide variety of hanging support structures. The power head adaptor 60 may be easily supported from the horizontal rod 92 of FIG. 14 by placing, or hooking, the adaptor onto the rod within the angled slot 94. Attachment adaptors 80 may be similarly be hooked upon a horizontal rod by using the angled slot configuration for the support opening within adaptor body. A user may easily install the adaptor onto a power equipment power head or attachment and then hook the assembly upon a support structure.

Some wall mounting and organizational systems on the market utilize an “L” or “V” cross-section wall bracket. A portion of the bracket extends out from the wall surface and allows items to hooked or hung upon the bracket edge. The angled slot 94 of the embodiment of FIG. 15, may also be used to hang a power head or attachment adaptor from the wall bracket storage system by hooking the bracket within the angled slot. Finally, a power head or attachment adaptor may be suspended from a pin, such as a nail or screw, positioned within the slot. As will be appreciated by those skilled in the art, the slot need not be a straight cut, but may be a curved shape when viewed from the side of the adaptor tube. In one embodiment, the angle of the slot is at 45 degrees as measured from the plane of the slot to the centerline of the attachment tube. In other alternative embodiments, the slot angle may be between 30 degrees to 85 degrees.

As will be appreciated by those skilled in the art, the diameter and end configurations of power heads and power head accessorizes vary among the power equipment manufacturers. The selection of the inner and outer diameters of the power head and attachment adaptor tubes is therefore important in accommodating the broadest range of manufacturer's power equipment products. In one embodiment of the present invention, the power head adaptor body has a maximum outside diameter of approximately 0.976 inches in the lower portion intended for insertion within the power head unit. The minimum inside diameter of the lower portion of the power head adaptor is approximately 0.840 inches. In another embodiment of the present invention, the attachment adaptor has a minimum inside diameter of approximately 1.02 inches in the lower portion intended for insertion over the attachment unit. The maximum outside diameter of the attachment adaptor body is approximately 1.125 inches. As will also be appreciated by those skilled in the art, manufactures commonly use female power heads which engage with male accessory attachments. Stated another way, the male accessory attachments insert within, or are receive within, the female power head assembly. However, some equipment manufactures may choose to use a male power head which inserts within female accessories. The inventive concepts embodied herein may be easily adapted for use with male power heads and female accessories. For example as depicted in FIG. 14, a storage assembly would comprise one adaptor 80 for storage of a male power head, and 3 adaptors 60 for storage of the mating mating female attachments.

In yet another embodiment of the present invention, the power head and attachment hanging storage adaptors are fabricated from rolled or extruded metal tube. The tube may be made from aluminum, steel, or other alloys as are readily known in the art. As will be appreciated by those skilled in the art, in other alternative embodiments the adaptor bodies may be formed from injection molded plastic or polymer, or may be a combination of injection molded and metal components.

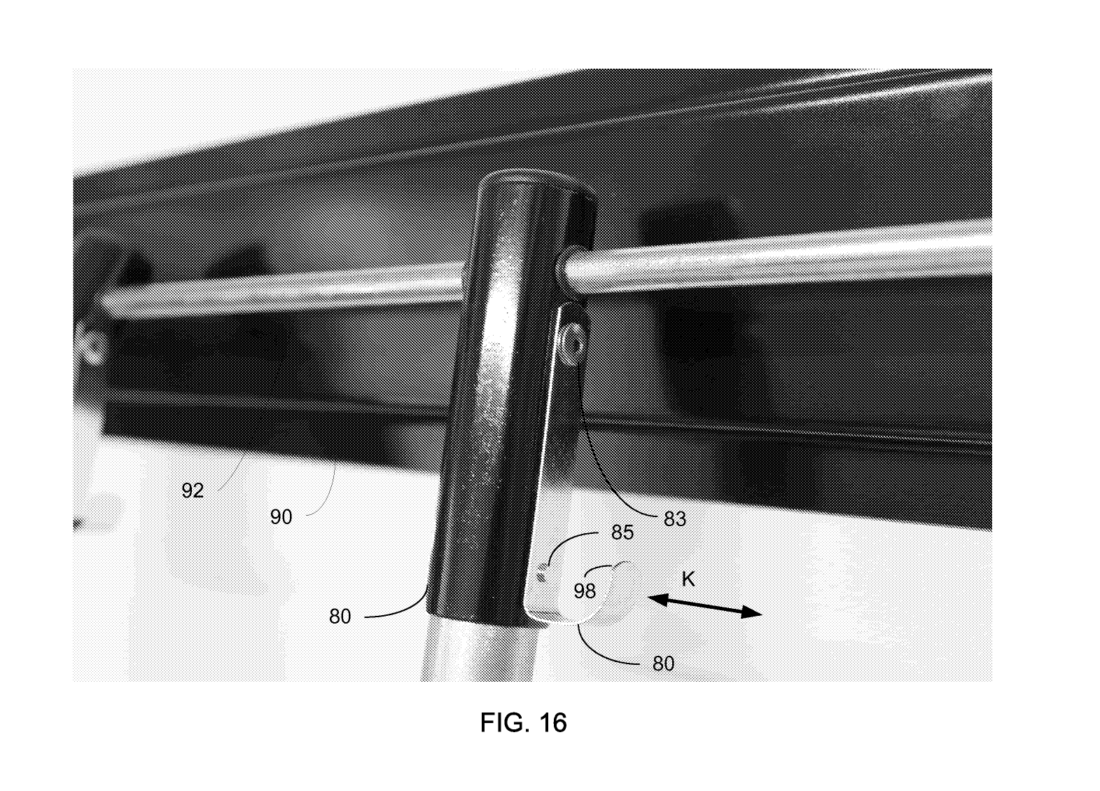

Another alternative embodiment of the invention is depicted in FIG. 16. As in prior embodiments, for power equipment using a pin within the body of the power head and a complimentary hole, or shallow recess, within the body of the attachment, a retention pin must be provided on the attachment storage adapter. As depicted in FIG. 16, an arm 84 is mounted on the exterior of the attachment adaptor 80 via a rivet 83. A retention pin 85 is affixed to the end of the arm 84. The arm 84 is fabricated from a spring or elastic material to allow the pin to be deflected away from the body of the adaptor body 80. The elastic properties of the arm 84 allow the pin 85 to be deflected away from the adapter body 80 and then spring back into place as depicted by Arrow “K”. In the un-deflected position, the retention pin 85 aligns with a hole in the body of the attachment storage adaptor 80. In the deflected position, the arm 84, retention pin 85, and rivet 83 do not interfere with engaging the adaptor 80 with an attachment configured with a retention pin as depicted in FIGS. 6-8.

An attachment 30 with a complimentary hole 34, or recess 34, may be inserted within the attachment storage adaptor 80. As the complimentary hole 34 in an attachment 30 aligns with the hole 86 in the attachment storage adaptor 80, the arm 84 and retention pin 85 snap down into position. The spring material of the arm 84 allows the pin 85 to deflect away from the body of attachment 30 as an attachment is inserted in to the attachment adaptor 80. When the pin 85 aligns with a complimentary hole 34 in an attachment, the spring force of the arm 84 urges the pin in the direction of Arrow “K” toward the body of the attachment adaptor 80. The pin 85 then positively retains an attachment 30 within the attachment storage adaptor 80. As further depicted in FIG. 16, the arm 84 is formed into a “J” configuration, thus provided a convenient hook 98 for a user to pull upon to retract retention pin 85. To release an attachment from the attachment adaptor 80, a user must pull upon the hook 98 outward away from the body of the attachment adaptor 80 in the direction of arrow “K”. As further depicted in FIG. 16, a wall bracket 90 supports the horizontal rod 92, which supports the adaptor 80.

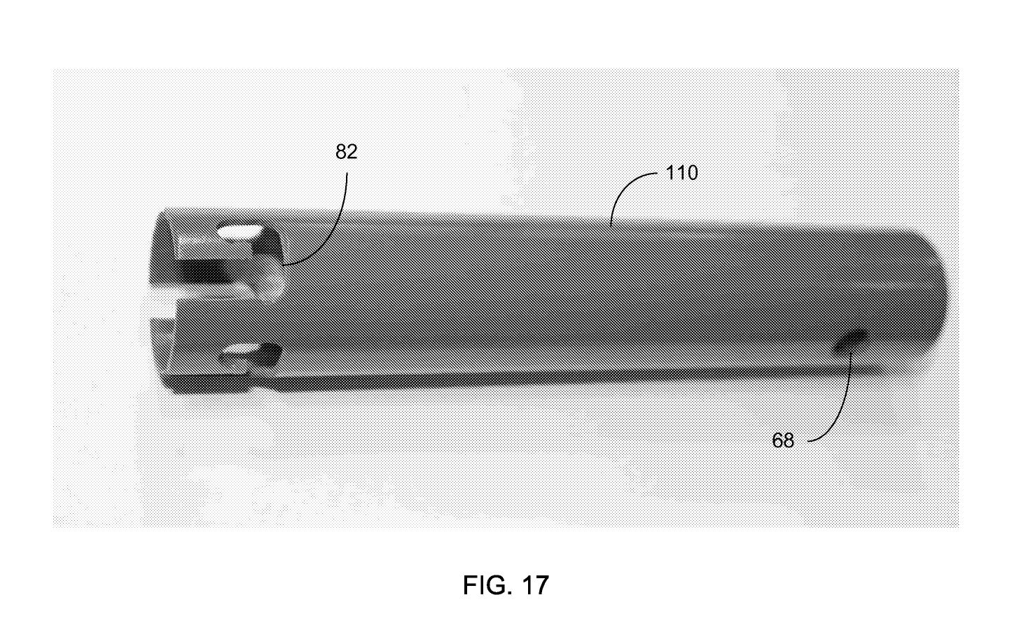

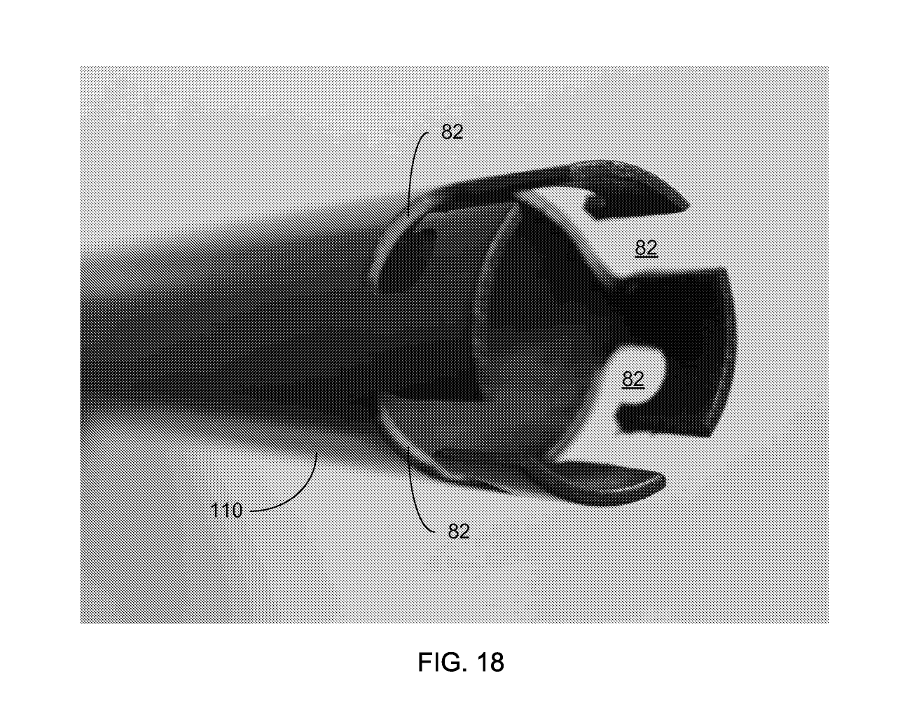

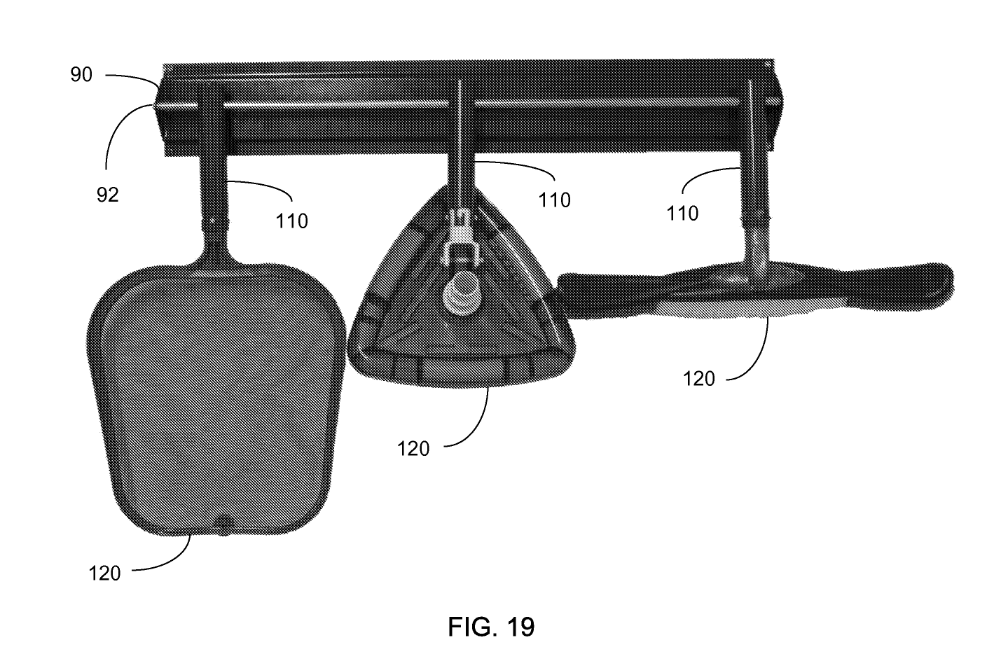

As will be appreciated by those skilled in the art, any of the male of female storage adaptors presented herein may also be applied to the storage of pool equipment. An example is depicted in FIG. 17 of a pool equipment storage adaptor 110. Similar to the storage embodiments depicted in FIGS. 6-8, the pool equipment storage adaptor 110 has a plurality of inverted “J” shaped cutouts 82 for receiving retention pins of the mating pool equipment. As in prior embodiments, an opening 68 in the body of the adaptor device 110 allows hanging the adaptor device and mated pool equipment 120 from a support structure. FIG. 18 depicts the end of the pool equipment storage adaptor 110 with “J” shaped cutouts 82 for engaging various pool attachments. Any of the prior storage adaptor embodiments presented herein and depicted in

FIGS. 4-17 may be applied to the storage of pool equipment. As depicted in FIG. 18, a plurality of pool equipment storage adaptors 110 are used to store various pool equipment 120 from horizontal support rod 92 on wall bracket 90.

While there has been shown a preferred embodiment of the present invention, it is to be understood that certain changes may be made in the forms and arrangement of the elements of the device without departing from the underlying spirit and scope of the invention.

What is claimed is:

1. An adaptor device for the hanging storage of a lawn trimmer attachment, the device comprising:
an adaptor body comprising a lower portion with a first distal end, and an upper portion with a second distal end, the adaptor body further comprising a central axis extending from the first distal end to the second distal end, and an exterior surface;
wherein an opening is formed within the lower portion of the adaptor body at first distal end configured for receiving a lawn trimmer attachment therein;
the adaptor lower portion comprising a hole within the lawn trimmer attachment opening for receiving a pin on the lawn trimmer attachment;
the adaptor upper portion comprising an opening for receiving a support structure therein; and
wherein a lawn trimmer attachment may be inserted within the adaptor device, the pin retaining the lawn trimmer attachment within the adaptor, and the adaptor and lawn trimmer attachment hung from the support structure.

2. The adaptor device of claim 1, wherein the opening for receiving the lawn trimmer attachment further extends thru the upper portions of the adaptor body and exits the second distal end to form an elongate tube.

3. The adaptor device of claim 1, wherein the hole for receiving the lawn trimmer attachment pin comprises a hole extending from the lawn trimmer attachment opening thru the body of the adaptor body to the exterior surface.

4. The adaptor device of claim 1, wherein a cutout is formed within the lower portion of the adaptor body, the cutout configured to allow the pin of the lawn trimmer attachment to be inserted therein, the cutout extending in a first direction from the first distal end towards the second distal end of the adaptor body, and substantially parallel to the central axis of the adaptor body;
the cutout then extending in a second direction from the termination of the first direction, the second direction comprising a first vector component from the second distal end to the first distal end, and a second vector component perpendicular to the central axis of the adaptor body, the cutout then terminating within the hole.

5. The adaptor device of claim 1, wherein a pin is supported by a spring element on the exterior surface of the adaptor body;
the pin and spring element configured to move from a first retracted position to a second extended position;
wherein a hole is formed thru the adaptor body from the opening within the lower portion to the exterior surface;
wherein the pin is urged to extend within the hole when the pin and spring element are in the second extended position; and
the pin configured to engage a corresponding recess in the lawn trimmer attachment.

6. The adaptor device of claim 1, wherein the opening for receiving the lawn trimmer attachment has a minimum dimension perpendicular to the central axis of the adaptor body of greater than 1.02 inch.

7. The adaptor device of claim 1, wherein the lower portion of the adaptor body has a maximum dimension perpendicular to the central axis of the adaptor body of less than 1.126 inch.

8. The adaptor device of claim 1, wherein the adaptor body comprises an extruded metal tube.

9. The adaptor device of claim 1, wherein the adaptor body comprises injection molded plastic.

10. The device of claim 1, wherein the adaptor body comprises thermo-formed plastic.

11. An adaptor device for the hanging storage of a lawn trimmer power head, the device comprising:
an adaptor body comprising a lower portion with a first distal end, and an upper portion with a second distal end, the adaptor body further comprising a central axis extending from the first distal end to the second distal end, and an exterior surface;
wherein an opening is formed within the lower portion at first distal end configured for receiving a portion of a lawn trimmer power head therein;
wherein at least one hole is formed thru the body of the adaptor body from the opening within the lower portion to the exterior surface;
wherein at least one pin is retained within the lower portion of the adaptor body, the pin configured to engage a corresponding recess in a lawn trimmer power head,
wherein the pin is urged to an extended position by a spring element, the pin in the extended position passing thru the at least one hole in the body of adaptor body and protruding out of the exterior surface of the adaptor body in a direction perpendicular to the central axis;
the adaptor upper portion comprising an opening for receiving a support structure therein; and
wherein a lawn trimmer power head may be inserted within the adaptor device, the pin retaining the lawn trimmer power head within the adaptor, and the adaptor and lawn trimmer power head hung from the support structure.

12. The adaptor device of claim 11, wherein the opening for receiving a portion of the lawn trimmer power head further extends thru the upper portions of the adaptor body and exits the second distal end to form an elongate tube.

13. The adaptor device of claim 11, wherein the at least one first pin and first spring element may be readily removed from the adaptor body.

14. The adaptor device of claim 13, wherein a lawn trimmer power head having an integral second pin may be inserted into the opening within the lower portion of the adaptor body, the integral second pin engaging the at least one hole.

15. The adaptor device of claim 11, wherein the lower portion of the adaptor body has a maximum dimension perpendicular to the central axis of the adaptor body of less than 0.976 inch.

16. The adaptor device of claim 11, wherein the opening within the lower portion of the adaptor body for receiving the lawn trimmer power head has a minimum dimension perpendicular to the central axis of the adaptor body of greater than 0.902 inch.

17. The adaptor device of claim 11, wherein the adaptor body comprises a metal tube.

18. The adaptor device of claim 11, wherein the adaptor body comprises injection molded plastic.

19. The adaptor device of claim 11, wherein the adaptor body comprises thermo-formed plastic.

20. An adaptor device for the hanging storage of a pool attachment, the device comprising:
an adaptor body comprising a lower portion with a first distal end, and an upper portion with a second distal end, the adaptor body further comprising a central axis extending from the first distal end to the second distal end, and an exterior surface;
wherein an opening is formed within the lower portion of the adaptor body at the first distal end configured for receiving a pool attachment therein;
the adaptor lower portion comprising a hole within the pool attachment opening for receiving a pin on the pool attachment;
wherein a cutout is formed within the lower portion of the adaptor body, the cutout configured to allow the pin of the pool attachment to be inserted therein, the cutout extending in a first direction from the first distal end towards the second distal end of the adaptor body, and substantially parallel to the central axis of the adaptor body;
the cutout then extending in a second direction from the termination of the first direction, the second direction comprising a first vector component from the second distal end to the first distal end, and a second vector component perpendicular to the central axis of the adaptor body, the cutout then terminating within the hole;
the adaptor upper portion comprising an opening for receiving a hanging support structure therein; and
wherein a pool attachment may be inserted within the adaptor device, the pin retaining the pool attachment within the adaptor, and the adaptor and pool attachment hung from the support structure.
